(19) United States
(12) Patent Application Publication
(10) Pub. No.: US 2008/0234910 A1
(43) Pub. Date: Sep. 25, 2008

(54) PROCESS AND SYSTEM TO CONTROL AN APB

(75) Inventors: Nicola Tristano, Matera (IT); Corrado Caruso, Bari (IT)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/051,121

(22) Filed: Mar. 19, 2008

(30) Foreign Application Priority Data
Mar. 22, 2007 (FR) 07 02101

(51) Int. Cl. G05B 11/01; F16D 55/04

(52) U.S. Cl. 701/78; 188/110

(57) ABSTRACT

The invention relates to a method for controlling a vehicle braking system comprising an electric control motor, a system for transmitting the control forces provided by the motor, at least one braking device for the wheels of a vehicle controlled by the control forces transmitted by the transmission device. The method comprises at the end of a braking system release cycle, three additional phases after braking is stopped: phase H: re-operating of the motor in said forward direction of rotation corresponding to the actuation of braking, phase I, detecting a value characteristic of the electric current powering the motor, phase J, operating the motor in the opposite direction of rotation to said forward direction then stopping the motor.

### BACKGROUND OF THE INVENTION

The invention relates to a method of operating a vehicle brake and in particular a method allowing a freeing (or placing at rest) of a braking system. The invention is more particularly applicable to automatic parking brake systems for motor vehicles.

An automatic parking brake system generally comprises an electric control motor which acts on devices for braking the wheels of a vehicle. The force communicated by the electric motor is transmitted to the braking devices by a transmission chain which can comprise a speed reducer, a worm transmission system and transmission cables. In certain systems the automatic parking brake acts on the brake pads of a disk brake.

Transmission of the loads from the motor to the braking devices is therefore done by a transmission chain and it is appropriate to ensure that, while placing the system at rest, when the automatic parking brake system orders the relaxation of the braking devices, the transmission chain does not contribute to counteracting this return to rest.

In transmission systems based on cables acting on disk brakes, there is a certain elasticity of the force transmission system. The return to rest of the brake pads occurs naturally. By reason of the elasticity of the transmission system, the latter can retain a certain residual braking force which counteracts the return of the pads to rest.

Additional mechanical components which make it possible to solve this problem are provided in certain systems. Such is the case, for example, for the systems described in documents US 2003/0116389 and EP-1462330. A solution is for example to provide one or more sensors making it possible to measure the tension in the transmission cables.

Moreover, certain systems provide for an additional release of the transmission devices (cables for example) so as to ensure that it is perfectly slack. However, such an arrangement lengthens the freeing time of the automatic parking brake system and lengthens its operating time during its following use. The curves of FIG. 1 illustrate the various operating phases of such a system in the course of a cycle comprising an actuation of the automatic parking brake system followed by a braking release (or freeing) cycle.

Represented dashed is the curve of the supply current powering the electric control motor of the automatic parking brake system. Represented as a continuous line is the force exerted by the cable (or the cables) transmitting the braking forces from the motor to the braking devices (brake pads). Represented dotted are the braking forces exerted by the braking devices.

In the course of a first phase, A, the motor is operated in a direction of rotation called its forward (or direct) direction of rotation. The force transmission cable is pulled but this action has no effect on the braking device. The flexibility (or slack) in the cable is eliminated. The level of the current powering the electric control motor corresponds to the resistance of the transmission system (of the speed reducer for example). In a known manner, there is a peak in the supply current to the motor when the latter is started.

In the course of a second phase B, the cable is stretched, the force corresponding to the preload of the absorption spring is not reached. The braking device gently begins to act. The play in the braking device is eliminated. In this instance the brake pads come into contact with the braking disk. But no braking force is created. The level of the supply current to the electric motor is small and constant.

In the course of a third phase C, the force on the cable increases as does the braking force. The electric motor supply current also increases as a consequence of the load exerted.

In the course of a fourth phase D, the desired braking force is reached. The motor supply current is cut off. The load of the transmission cable and the braking force remain constant on account of the irreversibility of operation of the transmission system or of the latching of the latter. The actuation cycle of the automatic parking brake system terminates. The system remains in this state until an intervention on the automatic parking brake system so that the latter orders a freeing or release of the braking for example with a view to starting the vehicle.

This release of the brake begins in the course of a fifth phase E. For this purpose, the electric motor is operated in the opposite direction (reverse) from its forward direction of rotation used during the actuation of the parking brake. There is therefore a current peak opposite to the current peak of the previous start. The braking force and the load of the transmission cable decrease. The level of the supply current required is small and relatively constant on account of the small energy required by this releasing of the cable and the return to rest of the braking device, as much as the energy in the brake contributes to the return to rest of the cable. Of course, the current required in this operating phase depends on the characteristics of the force transmission system used.

In the course of a sixth phase F, there is, in principle, no braking force in the braking device. However, an additional disengagement of the transmission cable is provided so as to ensure that the whole of the system returns to rest. It is almost certain that there is no longer any braking in the braking device due to the automatic brake system. However, if the end of the phase F cannot be detected exactly, the following phase G can be provided.

In the course of a seventh phase G, the supply to the motor is therefore retained for an additional time so as to ensure the complete freeing of the brake. This phase must be as short as possible to avoid untensioning the transmission cable by too large a quantity so as not to increase the reaction time of the automatic parking brake system during subsequent operation.

Theoretically the motor ought to have been stopped at the end of the operating phase F. The value of the motor supply current is not used to determine the end of phase F. On the other hand the detection of the force of the cable can be used.

### SUMMARY OF THE INVENTION

The subject of the invention relates to a method of controlling the automatic parking brake system making it possible to avoid a release of the cable without having to directly measure the force which it exerts thereon.

In an automatic parking brake system providing effective and comfortable operation for the driver, it is appropriate that actuation and freeing be as fast as possible.

Be that as it may, the freeing time of the system should be precisely what is required to bring the braking force back to a zero level which allows the vehicle to move. This implies that the time of the phase G corresponding to the release of the transmission cable is superfluous and prejudicial to the comfort of the driver.

The object of the invention is to solve these drawbacks and to use this time to effect perform the release of the cable without needing to directly measure the force exerted by the cable.

The invention therefore relates to a method of controlling a vehicle braking system comprising: an electric control motor, a system for transmitting the control forces provided by the motor, at least one braking device for the wheels of a vehicle, this braking device being controlled by the control forces transmitted by the transmission device and applying braking forces to the wheels of the vehicle, a locking device locking the operation of motor and/or the the force transmission device.

The method according to the invention comprises a sequence for releasing the brake system and this release sequence comprises the following phases: phase E: operating the motor in the direction of rotation opposite to the forward direction of rotation used for the actuation of braking, phase H: operating the motor in the said forward direction of rotation opposite to the previous direction, phase I, detecting a value characteristic of the electric current powering the motor, phase J, operating the motor in the opposite direction of rotation to said forward direction then stopping the motor.

According to a preferred mode of realization of the method of the invention at the commencement of phase E, the locking device unlocks the system for transmitting the control forces and/or the motor.

Provision may be made moreover between the phases E and H for the following phases: a phase E of sufficient duration to allow a release of the braking force applied by the braking device, a phase F of sufficient duration in the course of which the motor is kept operating in the opposite direction of rotation so as to allow a release of the tension in the control force transmission system.

Moreover, the method of the invention may provide between phases F and H, an additional operating phase G in the course of which the motor is kept operating in the opposite direction of rotation so as to allow complete release of the control force transmission system.

According to a preferred form of realization of the method of the invention, the detection of said value characteristic of the electric current powering the motor is done by measuring this electric current and by comparing the measured value with a prerecorded value.

Advantageously, the detection of said value characteristic of the electric current powering the motor is done by detecting a transition in the variation of said current as function of time.

According to variant of realization of the method of the invention, the detection of said value characteristic of the electric current powering the motor is done by detecting a transition of the variation of the current as a function of the variation of the displacement travel of the control force transmission system.

Advantageously, the braking system to which the method thus described is applied is an automatic parking brake system.

The invention also relates to a braking system implementing the method thus described.

### BRIEF DESCRIPTION OF THE DRAWINGS

The various subjects and characteristics of the invention will be more clearly apparent in the description which follows and in the appended figures which represent

FIG. 1, operating curves of an automatic parking brake system that have already been described previously,

FIG. 2a, a schematic representation of an automatic parking brake system making possible to implement the method of invention,

FIG. 2b, operating curves of an automatic parking brake system illustrating the method according to the invention,

FIG. 3 a flow chart of the method of operation according to the invention.

### DETAILED SUMMARY

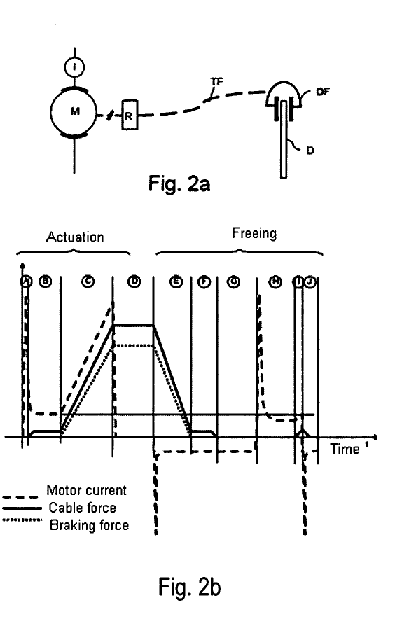

The automatic parking brake system of FIG. 2a comprises an electric control motor M capable of communicating a braking force to a braking device DF (brake pads) capable of braking the rotation of a disk D which is intended to be associated with a wheel of a vehicle.

The motor M provides a control force to the braking device DF advantageously by way of a speed reducer R and of a force transmission device TF (cables) which may be a force transmission cable.

A device for mechanical locking of the system is associated with the motor M or with the speed reducer R so as to lock the position of the system. This locking device is used after actuation of the automatic parking brake system to lock the system in the parking braking position and to be able to cut off the supply to the electric motor when the vehicle is immobilized.

Additionally, to be able to implement the method of the invention, an apparatus for measuring electric current I makes it possible to measure the motor supply current.

Referring to FIG. 2b an example of the realization of the operating method according to the invention will now be described.

FIG. 2b represents an operating cycle (actuation and freeing) of an automatic parking brake according to the invention.

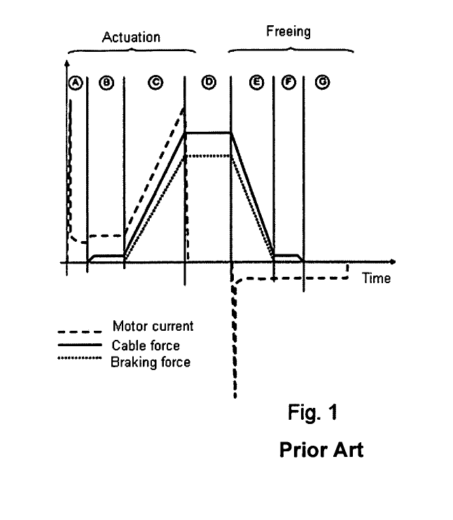

The curve of the supply current of the electric control motor of the automatic parking brake system is represented dashed as in FIG. 1. The force exerted by the cables transmitting the braking forces from the motor to the braking devices (to the brake pads) is represented by a continuous line. The braking forces exerted by the braking devices are represented dotted.

The actuation of the parking brake system is achieved through the operating phases A to D. By way of example, these phases are identical to phases A to D of FIG. 1. They are therefore recalled only briefly:

In the course of the first phase A the motor M is operated in a forward direction of rotation (direct) and it is possible to eliminate the slack in the force transmission device TF (cables) but this action has no effect on the braking device DF.

In the course of the second phase B. The braking device gently begins to act. The play in the braking device is eliminated. In this instance the brake pads come into contact with the braking disk. But no braking force is created. The level of the electric motor supply current is low and constant.

In the course of the third phase C, the braking force acts and by increasing, the electric motor supply current also increases as a consequence.

In the course of the fourth phase D, the desired braking force is reached. The motor supply current is cut off. The mechanical tension of the transmission cable and the braking force remain constant on account of the latching of the parking brake system and of the reaction of the brake. The actuation cycle of the automatic parking brake system terminates. The system remains in this state until an intervention on the automatic parking brake system so that the latter orders a release of braking.

The operation of the freeing of the braking system according to the invention will now be described. According to the example illustrated by FIG. 2b this freeing comprises six phases instead of three phases in the system illustrated by FIG. 1.

Phases E, F, G correspond to phases E, F, G of FIG. 1.

In the course of the fifth phase E, the order to free the braking has been given. The freeing (or release) cycle of the automatic brake system begins. For this purpose, the electric motor is operated in the opposite direction of rotation to the forward direction of rotation used for the actuation of braking (reverse). There is therefore a current peak opposite to the current peak of the previous start. As in FIG. 1, the braking force and the load of the transmission cable decrease. The level of the supply current required is small and relatively constant on account of the small energy required by this release of the cable and the return to rest of the braking device. The current required in this operating phase depends on the characteristics of the force transmission system used.

In the course of the sixth phase F the motor is kept operating (in reverse) so as to allow an additional disengagement of the transmission cable so as to ensure that the whole of the system returns to rest. On completion of this phase F, in principle, there is no longer any braking force in the braking device. However, the end of this phase F cannot be detected exactly.

This is why provision is advantageously made for the seventh phase G in the course of which the supply to the motor (in reverse) is retained for an extra time so as to ensure the complete release of the transmission cable and the complete freeing of the brake.

In a preferred manner, phase G is shorter than phase G of FIG. 1 insofar as, as described hereinbelow, the exact moment of release is measured. It can be stored for subsequent implementations of the parking brake according to the invention.

In the course of an eighth phase H, the motor is energized again in the forward direction of rotation corresponding to the actuation of the braking system (direct) this possibly leading to an actuation of braking. However, the motor supply current is kept small after the starting spike and the transmission cables still do not transmit any force.

In the course of a ninth phase I as soon as the slack in the cables is removed, the force of the cables tends to increase, thereby causing an increase in the motor supply current. This commencement of motor current increase is detected.

In the course of a tenth phase J the direction of rotation of the motor is then reversed for a very short time so as to allow the cable to be untensioned again. The motor is then stopped thereafter.

The three phases H, I and J do not affect the driver maneuvers and neither are they affected by any maneuver of the driver such as by the maneuvering of the service brake.

The fact of pulling precisely on the cable in order to retension it does not influence the behavior of the service brake. In particular, in the case where the transmission cable is furnished with an absorption spring, this gentle traction on the cable may reach the preload of the spring without this having any influence on the braking device.

The advantage of this method is of placing the parking brake system, when it is placed at rest, in a state which will allow its almost-immediate actuation when next ordered. Such a method therefore makes it possible to improve the driver's comfort.

The subject of the invention therefore relates to a method making it possible to ensure that, when the automatic parking brake system orders the release of parking braking, the system for transmitting the control forces from the motor to the braking devices does not retain any residual force which counteracts the return to rest of the braking devices. Likewise, the method of the invention makes it possible to ensure that the control force transmission system does not relax by too large a quantity so that the following actuation of the parking brake system is effective as rapidly as possible.

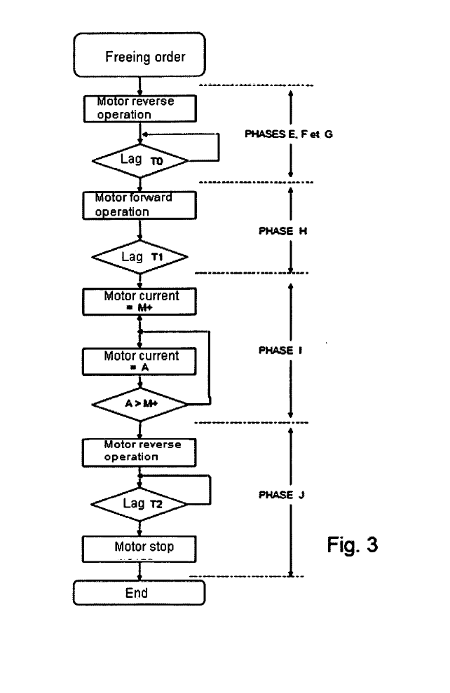

FIG. 3 represents a flow chart of the operation of the method according to the invention. It represents only phases E to J of the curves of FIG. 2b corresponding to the freeing of the parking brake system.

When the driver orders the freeing of the parking brake, the electric motor of the parking brake system is operated in reverse for a time TO corresponding to phases E, F and G.

Thereafter, the electric motor is operated forwards for a time T1, this corresponding to phase H.

During phase I, the supply current A absorbed by the electric motor is measured and is compared with a prerecorded value M+. When the value A becomes greater than the value M+, phase J is instigated. The motor is operated in reverse for a determined very short time preferably substantially equal to or slightly greater than the duration of phase I. Next the motor is stopped. The parking brake system is reset to rest.

The invention therefore relates to a method using principally the value of the strength of the supply current absorbed by the electric motor. According to this method it is possible to ensure that a minimum determined slack is left in the control force transmission cables after the system stops.

The method according to the invention is therefore based on the possibility of detecting the motor supply current so as to detect the exact instant at which a braking device begins to be effective once pulled by the control force transmission system, by the traction cables for example.

Should a preloaded spring be used, a minimum force level is necessary to begin to actuate the braking device. A necessary force transition is perceivable in the transmission cable as well as at the level of the motor. This operating phase is detected by detecting the motor supply current. As soon as this is detected, the operation of the motor is reversed briefly, then it is stopped. The parking brake system is thus reset to a state of readiness to operate with the force transmission system (cable) exhibiting little or no slack. At the following actuation, the parking brake system will therefore be effective almost immediately, and this will be more comfortable for the driver and afford him greater security.

Advantageously, the system according to the invention, for implementing the method according to the present invention, comprises a computer of known type commonly used in the automobile industry.

Advantageously, the computer comprises a microcontroller furnished with a permanent memory for program storage, in particular for implementation according to the present invention of ROM, PROM, EPROM EEPROM, and/or flash EEPROM type.

Advantageously, the computer is linked to a data bus for example the bus marketed under the denomination “CAN”.

The computer comprises inputs for the acquisition of data, in particular electrical voltages (or their digitized values) and an output for controlling brake actuation.

It is obvious that the implementation of the method described for the control of drum brakes and/or for the direct application of forces to the brake linings, without involving a cable (motor or caliper) does not depart from the scope of the invention.

1. Method of controlling a vehicle braking system comprising: an electric control motor (M), a system for transmitting the control forces (TF) provided by the motor, at least one braking device (DF) for the wheels of a vehicle controlled by the control forces transmitted by the transmission device and applying braking forces to the wheels of the vehicle, a locking device locking the operation of the force transmission device and/or the motor, a sequence for releasing the braking system comprising the phase E: operating the motor in the direction of rotation opposite to the forward direction of rotation used for the actuation of braking, characterized in that the sequence for releasing the braking system furthermore comprises the following phases: phase H: operating the motor in the said forward direction of rotation opposite to the previous direction, phase I, detecting a value characteristic of the electric current powering the motor, phase J, operating the motor in the opposite direction of rotation to said forward direction then stopping the motor.

2. Method according to claim 1, characterized in that at the commencement of phase E, the locking device unlocks the system for transmitting the control forces and/or the motor.

3. Method according to claim 2, characterized in that it comprises between phases E and H the following phases: a phase E of sufficient duration to allow a release of the braking force applied by the braking device, a phase F of sufficient duration in the course of which the motor is kept operating in the opposite direction of rotation so as to allow a release of the tension in the control force transmission system (TF).

4. Method according to claim 3, characterized in that it comprises between phases F and H, an additional operating phase G in the course of which the motor is kept operating in the opposite direction of rotation so as to allow complete release of the control force transmission system.

5. Method according to claim 1, characterized in that the detection of said value characteristic of the electric current powering the motor is done by measuring this current and by comparing the measured value with a prerecorded value.

6. Method according to claim 1, characterized in that the detection of said value characteristic of the electric current powering the motor is done by detecting a transition in the variation of said current as a function of time.

7. Method according to claim 1, characterized in that of said value characteristic of the electric current powering the motor is done by detecting a transition of the variation of the current as a function of the variation of the displacement travel of the control force transmission system.

8. Method according to claim 1, characterized in that the braking system is an automatic parking brake system.

9. Braking system implementing the method according claim 1.
